(19) United States
(12) Patent Application Publication
(10) Pub. No.: US 2011/0136069 A1
(43) Pub. Date: Jun. 9, 2011

(54) BURNING EQUIPMENT

(75) Inventors: Naoya Ryoki, Osaka (JP); Naoko Matsuda, Osaka (JP); Hiroyuki Naka, Osaka (JP); Shinji Arimoto, Osaka (JP)

(73) Assignee: PANASONIC CORPORATION, Osaka (JP)

(21) Appl. No.: 13/056,888

(22) PCT Filed: May 25, 2010
(86) PCT No.: PCT/JP10/03474

§ 371 Date: Jan. 31, 2011

(30) Foreign Application Priority Data
May 28, 2009 (JP) 2009-128365

(51) Int. Cl. F27D 7/02; F27B 9/10; F27B 9/26; F27B 9/40

(52) U.S. Cl. 432/152; 432/200; 432/128

(57) ABSTRACT

The present invention has an object to provide burning equipment that can prevent uneven burning and increase productivity. The burning equipment of the present invention includes: a furnace body (13) having an inner space in which a powdery or granular subject to be treated (11) is burned; a gas ejection portion (21) having an opening for ejecting an atmospheric gas from above the subject to be treated (11) which is conveyed in the inner space of the furnace body (13); a gas supply portion (18) for supplying the atmospheric gas from a side wall (13c) of the furnace body (13) to the gas ejection portion (21); and a heating portion (24a, 24b) for controlling temperature distribution in the inner space of the furnace body (13).

### TECHNICAL FIELD

The present invention relates to burning equipment for burning a powdery or granular subject to be treated that is conveyed in a furnace body.

### RELATED ART

Conventionally, heat treatment called burning has been widely performed. Burning is performed on, for example, a powdery or granular subject to be treated that is made of a metal material or an inorganic material for the purpose of a synthesis with an oxidation reaction or a reduction reaction, the removal of an impurity, improvement in crystal structure, or particle growth. Hereinafter, the powdery or granular subject to be treated is simply referred to as powder.

Equipment for burning a small amount of powder widely used on a laboratory scale is a small batch type furnace. Meanwhile, equipment for continuously burning a large amount of powder widely used is a large continuous conveying type furnace. Continuous conveying type equipment is classified into several groups depending on powder conveying methods.

A rotary burning furnace is typical equipment for directly conveying powder. The rotary burning furnace rotates a cylindrical furnace core tube. Thus, powder can be burned and conveyed while being stirred in the furnace core tube.

The rotary burning furnace is suitable for uniformly applying heat to the powder. However, in highly corrosive powder, a surface of the furnace core tube made of a metal is corroded and released, and the released object may be mixed into the powder as an impurity. Methods of preventing an impurity from being mixed include a method of frequently replacing furnace core tubes or covering a surface of a furnace core tube with an inert metal such as platinum or a ceramic. However, in these methods, furnace core tubes cost very high. Another method is conceivable in which a furnace core tube itself is made of a ceramic. However, there is a high risk that a thermal shock breaks a furnace core tube, and it is difficult to produce a large ceramic furnace core tube.

For the above reasons, in highly corrosive powder, a method has been widely used in which powder is carried in a box-shaped or plate-shaped carrying member made of a ceramic having corrosion resistance, and the carrying member carrying the powder is conveyed. As a conveying medium of the carrying member, a hydraulic pusher (pusher furnace), a ceramic roller conveyor (roller hearth furnace), a metal mesh belt conveyor (mesh belt furnace), or the like is used (for example, see Patent Literature 1).

When subjects to be treated, not limited to powder, are continuously burned, an atmospheric gas required for a desired chemical reaction needs to be supplied into a furnace. Desirably, the atmospheric gas is uniformly brought into contact with all the subjects to be treated. This is to uniformly burn all the subjects to be treated.

As a method for uniformly burning subjects to be treated, a method is known in which an atmospheric gas is supplied so that a flow velocity of the atmospheric gas flowing along a carrying surface on which subjects to be treated are carried does not reach zero depending in any spots (for example, see Patent Literature 2).

FIG. 9 is a sectional view showing the configuration of conventional burning equipment described in Patent Literature 2. Specifically, FIG. 9 shows a section of a furnace body 3 cut along a plane perpendicular to the conveying direction of a carrying member 2 carrying a subject to be treated 1. The conveying direction of the carrying member 2 is perpendicular to a sheet of FIG. 9. As shown in FIG. 9, in the burning equipment, a plurality of carrying members 2 carrying subjects to be treated 1 are stacked in multiple stages in the height direction of the furnace body 3, and are simultaneously conveyed. Further, an air supply pipe 4 for ejecting an atmospheric gas toward the carrying member 2 is embedded in the side wall of the furnace body 3, and a gas ejection port 5 that is one end of the air supply pipe 4 is placed in the inner surface of the side wall of the furnace body 3. Thus, the atmospheric gas supplied to the air supply pipe 4 outside the furnace body 3 is ejected from the gas ejection port 5 placed in one inner side surface of the furnace body 3, and flows along a carrying surface on which the subject to be treated 1 is carried. The burning equipment controls a supply amount of the atmospheric gas so that a flow velocity of the atmospheric gas ejected from the one inner side surface of the furnace body 3 does not reach zero in any spots.

### CITATION LIST

### Patent Literature

Patent Literature 1: Japanese Patent Laid-Open No. 2000-203947
Patent Literature 2: Japanese Patent Laid-Open No. 2004-198038

### SUMMARY OF INVENTION

To achieve the above-described object, the present invention provides burning equipment including: a furnace body having an inner space in which a powdery or granular subject to be treated is burned; a gas ejection portion having an opening for ejecting an atmospheric gas from above the subject to be treated which is conveyed in the inner space of the furnace body; a gas supply portion for supplying the atmospheric gas from the side wall of the furnace body to the gas ejection portion; and a heating portion for controlling temperature distribution in the inner space of the furnace body.

### BRIEF DESCRIPTION OF DRAWINGS

FIG. 1 is a sectional view showing an exemplary configuration of burning equipment according to Embodiment 1 of the present invention wherein, specifically, FIG. 1(a) shows an example of a section of the burning equipment according to Embodiment 1 of the present invention cut along a plane perpendicular to the conveying direction of a carrying member carrying powder, and FIG. 1(b) shows an example of a section of the burning equipment according to Embodiment 1 of the present invention cut along a vertical plane along the conveying direction of the carrying member carrying powder.

FIG. 2 shows an exemplary configuration of the control block of the burning equipment according to Embodiment 1 of the present invention.

FIG. 3 shows an exemplary configuration of the air supply pipe of the burning equipment according to Embodiment 1 of the present invention.

FIG. 4 is a sectional view showing another exemplary configuration of the burning equipment according to Embodiment 1 of the present invention.

FIG. 5 schematically shows an exemplary configuration of the gas introduction mechanism of the burning equipment according to Embodiment 1 of the present invention.

FIG. 6 schematically shows an example of a configuration for controlling a temperature in the furnace body of the burning equipment according to Embodiment 1 of the present invention.

FIG. 7 is a sectional view showing another exemplary configuration of the burning equipment according to Embodiment 1 of the present invention.

FIG. 8 is a sectional view showing an exemplary configuration of burning equipment according to Embodiment 2 of the present invention wherein, specifically, FIG. 8(a) shows an example of a section of the burning equipment according to Embodiment 2 of the present invention cut along a plane perpendicular to the conveying direction of a carrying member carrying powder, and FIG. 8(b) shows an example of a section of the burning equipment according to Embodiment 2 of the present invention cut along a vertical plane along the conveying direction of the carrying member carrying powder.

FIG. 9 is a sectional view showing the configuration of conventional burning equipment.

### DESCRIPTION OF EMBODIMENTS

Now, embodiments of the present invention will be described with reference to the drawings. Components corresponding to the foregoing components are denoted by the same reference numerals, and the descriptions thereof are omitted where appropriate. In the embodiments below, a powdery or granular subject to be treated is simply referred to as powder.

### Embodiment 1

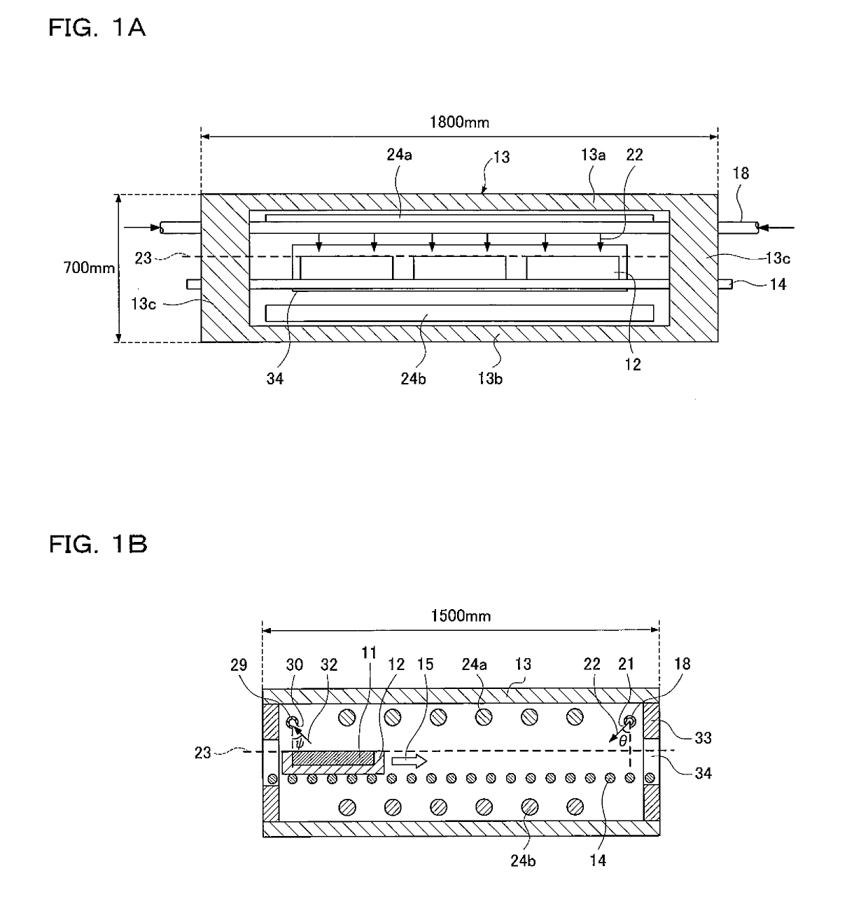

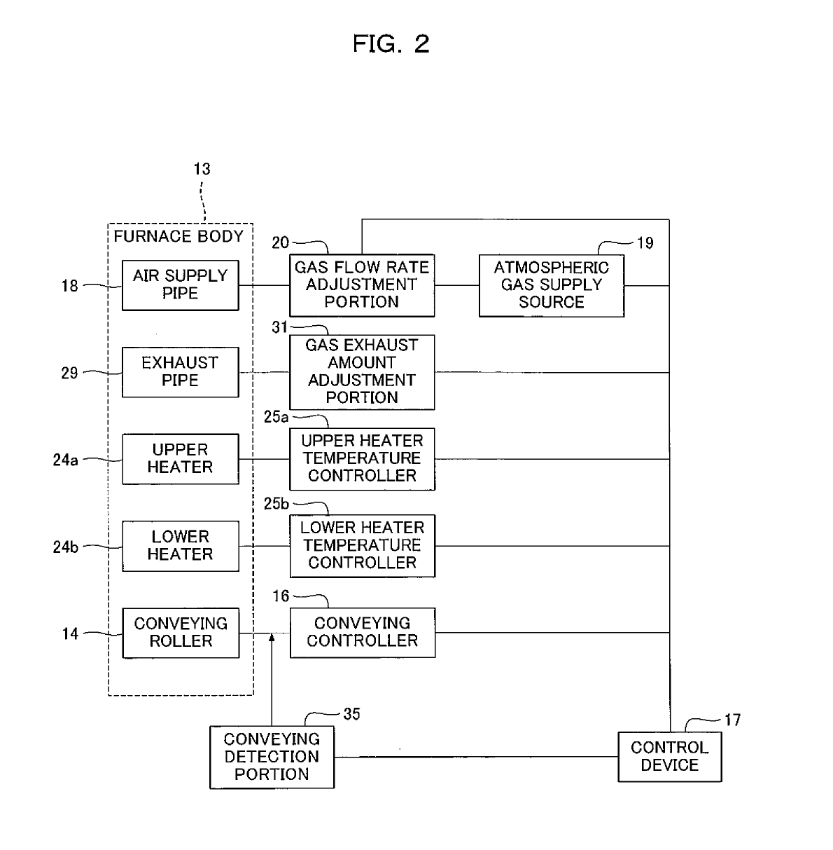

FIGS. 1(a) and 1(b) are sectional views showing an exemplary configuration of burning equipment according to Embodiment 1 of the present invention. Specifically, FIG. 1(a) shows a section of a furnace body cut along a plane perpendicular to the conveying direction of a carrying member carrying powder, and FIG. 1(b) shows a section of the furnace body cut along a vertical plane along the conveying direction of the carrying member carrying powder. FIG. 2 shows an exemplary configuration of the control block of the burning equipment according to Embodiment 1 of the present invention.

The burning equipment burns powder 11 in the inner space of a furnace body 13. In the inner space of the furnace body 13, a carrying member 12 is conveyed. The carrying member 12 carries the powder 11. In this embodiment, as shown in FIG. 1(b), the carrying member 12 is horizontally conveyed by rotation of a plurality of conveying rollers 14 horizontally provided. Thus, the upper side of the plurality of conveying rollers 14 is the conveying path of the carrying member 12. The horizontal direction is the lateral direction of sheet of FIG. 1(b). The carrying member 12 is conveyed from left to right in FIG. 1(b) and from front to back in FIG. 1(a) along a conveying direction 15 shown by an arrow in FIG. 1(b). The conveying roller 14 is connected to a conveying controller 16 as shown in FIG. 2, and the conveying controller 16 controls the rotation of the conveying roller 14. The conveying controller 16 is connected to a control device 17, and the control device 17 controls a target value or the like of rotational speed of the conveying roller 14.

In this embodiment, the vertical height of the furnace body 13 is 700 mm, and the lateral width of the furnace body 13 perpendicular to the vertical direction of the furnace body 13 and the conveying direction 15 is 1800 mm. The lengths of zones described later along the conveying direction 15 are 1500 mm. As a matter of course, the sizes are not limited to these, but may be set as appropriate depending on an amount of the powder 11 to be treated.

FIG. 1(b) shows only one carrying member 12 for simplicity, but a plurality of carrying members 12 may be arranged along the conveying direction 15 and continuously conveyed. Thus, the powder 11 carried by the carrying members 12 which are continuously conveyed along the conveying direction 15 can be continuously burned. The carrying members 12 may be arranged at regular intervals to prevent collision between the carrying members or may be arranged without intervals.

FIG. 1(a) shows a case where three carrying members 12 are arranged in a lateral direction perpendicular to the conveying direction 15. The lateral direction is the lateral direction of sheet of FIG. 1(a). In this case, the three carrying members 12 arranged in the lateral direction can be simultaneously conveyed. Thus, the powder 11 carried by the carrying members 12 arranged in the lateral direction can be simultaneously burned. Thus, with the burning equipment of this embodiment, the carrying members 12 in three rows along the conveying direction 15 may be arranged in the lateral direction perpendicular to the conveying direction 15, and the plurality of carrying members 12 in three rows can be simultaneously continuously conveyed.

Next, the gas introduction mechanism of the burning equipment will be described. The gas introduction mechanism introduces an atmospheric gas required for a desired chemical reaction from a side wall 13c of the furnace body 13 to the inner space of the furnace body 13. In this embodiment, the gas introduction mechanism includes an air supply pipe 18, an atmospheric gas supply source 19 for supplying the atmospheric gas to the air supply pipe 18, a gas flow rate adjustment portion 20 for controlling the flow rate of the atmospheric gas supplied from the atmospheric gas supply source 19 to the air supply pipe 18, and a gas ejection portion 21 provided in the air supply pipe 18. As shown in FIG. 2, the atmospheric gas supply source 19 and the gas flow rate adjustment portion 20 are connected to the control device 17, and the control device 17 controls a gas supply operation by the atmospheric gas supply source 19 and the flow rate adjustment operation of the atmospheric gas by the gas flow rate adjustment portion 20. As the gas flow rate adjustment portion 20, for example, a regulator, a damper, or a fan may be used.

The air supply pipe 18 as a gas supply portion passes through the furnace body 13 in the lateral direction as shown in FIG. 1(a). The air supply pipe 18 is placed above the conveying path of the carrying member 12 in the furnace body 13, and the air supply pipe 18 supplies the atmospheric gas from the side wall 13c of the furnace body 13 to the gas ejection portion 21. The air supply pipe 18 is connected to the atmospheric gas supply source 19 outside the furnace body 13. The gas flow rate adjustment portion 20 is interposed between the air supply pipe 18 and the atmospheric gas supply source 19 outside the furnace body 13.

Multiple gas ejection portions 21 are provided in the side surface of the air supply pipe 18 in the furnace body 13. The gas ejection portion 21 ejects the atmospheric gas from above the powder 11 conveyed in the inner space of the furnace body 13. In this embodiment, the gas ejection portion 21 is an opening formed in the side surface of the air supply pipe 18, and the atmospheric gas is ejected through the opening. Specifically, the gas ejection portion 21 placed in the furnace body 13 ejects the atmospheric gas in a gas ejection direction 22 crossing the conveying direction 15. Thus, the atmospheric gas supplied from outside the furnace body 13 through the air supply pipe 18 to the gas ejection portion 21 is ejected from the gas ejection portion 21 toward the powder 11 carried by the carrying member 12.

FIG. 1(b) shows an example of the gas ejection direction 22 with an arrow. In this embodiment, the gas ejection direction 22 is set so that an angle formed by a normal to an imaginary surface 23 on the same level as the surface layer of the powder 11 and the gas ejection direction 22 is 45°. A distance between the imaginary surface 23 and the gas ejection portion 21 is 70 mm.

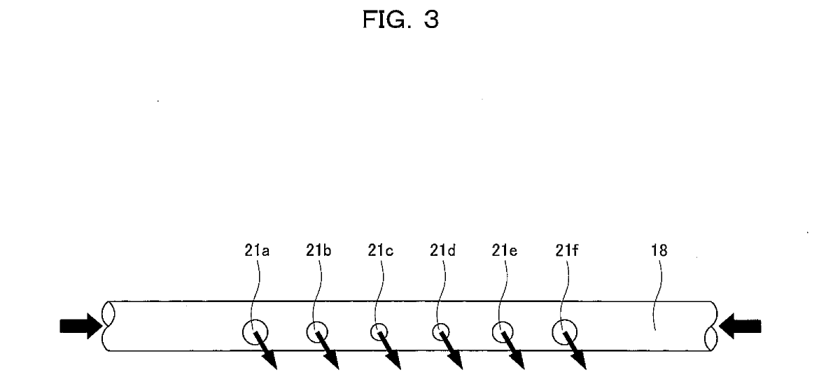

FIG. 3 shows details of the air supply pipe 18. In this embodiment, six circular gas ejection portions (openings) 21a, 21b, 21c, 21d, 21e and 21f are provided at intervals of 160 mm on the side surface of the air supply pipe 18 in the furnace body 13. The air supply pipe 18 has a cylindrical shape with an inner diameter of 30 mm. Of the six gas ejection portions 21a to 21f, the outermost gas ejection portions (openings) 21a and 21f have a diameter of 13 mm, and the second outermost gas ejection portions (openings) 21b and 21e have a diameter of 11 mm, and the innermost gas ejection portions (openings) 21c and 21d have a diameter of 9 mm. In other words, the gas ejection portions (openings) 21 closer to the inner side have smaller areas. With such a configuration, when the atmospheric gas of the same flow rate is supplied from each of opposite ends of the air supply pipe 18, variations in the flow rate of the atmospheric gas ejected from the gas ejection portions 21a to 21f can be reduced.

In the burning equipment, the atmospheric gas is ejected from each of the plurality of gas ejection portions 21a to 21f such that any of Conditions 1 to 4 below is satisfied. Specifically, the flow rate of the atmospheric gas supplied to the air supply pipe 18, the sectional area of the inner hole of the air supply pipe 18, the area of the gas ejection portion (opening) 21, the arrangement of the air supply pipe 18 and the gas ejection portion 21, the gas ejection direction 22, and the like are set such that any of Conditions 1 to 4 below is satisfied.

U=0.0315×S^{-0.5}×Q

H/cos θ≦80

U<Uc (Condition 1)

U=(1.694+0.0105×H/cos θ)×S^{-0.5}×Q×cos θ/H

80<H/cos θ≦150

U<Uc (Condition 2)

U=(5.476−0.0142×H/cos θ)×S^{-0.5}×Q×cos θ/H

150<H/cos θ>300

U<Uc (Condition 3)

U=S^{-0.5}×Q×cos θ/H

H/cos θ>300

U<Uc (Condition 4)

where S is the area [mm²] of the gas ejection portion (opening) 21, Q is the flow rate [mm³/s] of the atmospheric gas ejected from the gas ejection portion 21, H is a distance [mm] between the imaginary surface 23 and the gas ejection portion 21, θ is an angle [°] formed by the normal to the imaginary surface 23 and the gas ejection direction 22, U is the flow velocity [mm/s] of the atmospheric gas in the imaginary surface 23 on the extension line of the gas ejection direction 22, and Uc is a critical friction velocity [mm/s] at which the powder 11 flies.

Conditions 1 to 4 described above have been discovered by numerical analyses under various conditions. Specifically, Conditions 1 to 4 have been discovered by changing S, Q, H and θ to various values and obtaining a relationship between the flow rate Q of the atmospheric gas ejected from the gas ejection portion 21 and the flow velocity U of the atmospheric gas in the imaginary surface 23.

In this embodiment, the angle θ formed by the normal to the imaginary surface 23 and the gas ejection direction 22 is 45°, and the distance H between the imaginary surface 23 and the gas ejection portion 21 is 70 mm, and thus H/cos θ is 100 mm. For example, of the gas ejection portions shown in FIG. 3, the gas ejection portions 21b and 21e having a diameter of 11 mm have an area S of 95 mm². Thus, if the atmospheric gas is supplied to the air supply pipe 18 so that the atmospheric gas is ejected from the gas ejection portions 21b and 21e at a flow rate Q of 6 liters/min, that is, 100000 mm³/s, the flow velocity U of the atmospheric gas ejected from the gas ejection portions 21b and 21e in the imaginary surface 23 is 280 mm/s. This value substantially matches an actually measured value.

The critical friction velocity Uc can be calculated by the following known expression.

Uc=A×{Dₚ×g×(ρₚ−ρₐ)/ρₐ}^{0.5}

where Dₚ is the particle size [m] of the powder, g is a gravity acceleration [m/s²], ρₚ is the density [kg/m³] of the powder, and ρₐ is the density [kg/m³] of the atmospheric gas. The particle size can be measured by laser diffraction type particle size distribution measurement. The particle size may be evaluated by a median diameter. A is a proportional constant. The value differs depending on the type of powder or the state of bonding between adjacent particles, and the value can be separately calculated by an experiment.

In this embodiment, metal powder is used as the powder, and oxygen is used as the atmospheric gas. In the powder to be burned in this embodiment, Dₚ is 1×10⁻⁵ m, ρₚ is 4500 kg/m³, ρₐ is 0.36 kg/m³, and A is 0.4. Thus, the critical friction velocity Uc is 440 mm/s. g is 9.8 m/s². In the gas ejection portions 21b and 21e having a diameter of 11 mm described above, the flow velocity U is 280 mm/s and does not exceed the critical friction velocity Uc. Thus, the atmospheric gas can be ejected such that the conditions described above are satisfied.

As described above, the flow rate of the atmospheric gas supplied to the air supply pipe 18, the sectional area of the inner hole of the air supply pipe 18, the area of the gas ejection portion (opening) 21, the arrangement of the air supply pipe 18 and the gas ejection portion 21, the gas ejection direction 22, and the like are set such that any of Conditions 1 to 4 above is satisfied for all the gas ejection portions 21. Thus, even when the plurality of carrying members 12 arranged in multiple rows are simultaneously continuously conveyed to increase productivity, the powder 11 is prevented from flying. Further, a sufficient atmospheric gas can be uniformly brought into contact with the surface layer of the powder 11, thereby facilitating a desired chemical reaction. Furthermore, even with a smaller amount of gas supplied than in a case where the gas ejection portion 21 is placed in the side wall 13c or a lower wall 13b of the furnace body 13, the concentration of the atmospheric gas brought into contact with the powder 11 can be increased. This can reduce cost for buying or generating the atmospheric gas.

As the distance H is increased between the imaginary surface 23 on the same level as the surface layer of the powder 11 and the gas ejection portion 21, the flow velocity U of the atmospheric gas in the imaginary surface 23 becomes smaller. Thus, as the distance H is increased, any of Conditions 1 to 4 above can be more easily satisfied. However, as the distance H is increased, the inner space of the furnace body 13 is increased and the amount of atmospheric gas supplied that is required for burning is also increased. This increases cost for buying or generating the atmospheric gas, and increases energy cost for heating the atmospheric gas in the furnace. To prevent this, the distance H is preferably 300 mm or less, and more preferably 200 mm or less.

The configuration of the air supply pipe 18 is not limited to the configuration of FIG. 3. The arrangement or number of the gas ejection portions 21 is set depending on the number or arrangement of the conveyed carrying members 12, the amount of carried powder 11, or the like.

The case where the atmospheric gas is supplied from opposite ends of the air supply pipe 18 has been described. However, the atmospheric gas may be supplied from only one end of the air supply pipe 18. In this case, the area of the gas ejection portion (opening) 21 is set to be smaller with increasing distance from the end from which the gas is supplied. This can reduce variations in the flow rate of the atmospheric gas ejected from the gas ejection portion 21. As described above, the atmospheric gas is supplied from at least one side of the side walls 13c of the furnace body 13 facing each other in the lateral direction perpendicular to the conveying direction 15 (lateral direction of sheet of FIG. 1(a)), thereby allowing a plurality of furnace bodies to be stacked in multiple stages as described later in Embodiment 2.

Further, the case has been described where some of the plurality of gas ejection portions 21 have different opening areas, but all the openings may have the same area as long as any of Conditions 1 to 4 above is satisfied.

The case has been described where the air supply pipe 18 has a cylindrical shape, and the gas ejection portion 21 is a circular opening. However, the shapes of the air supply pipe 18 and the gas ejection portion provided in the air supply pipe 18 are not limited to these, but for example, a rectangular air supply pipe or a rectangular opening may be provided. Further, the case has been described where the gas ejection portion 21 is an opening provided in the side surface of the air supply pipe 18. However, not limited to this, the gas ejection portion may be, for example, a branch pipe branching from the air supply pipe. In this case, an opening is provided, for example, at the tip of the branch pipe. To the shape of the opening from which the atmospheric gas is ejected, the above-described conditions may be applied except for special shapes. The special shapes include, for example, a spiral shape or a swastika shape.

In this embodiment, the case has been described where the three carrying members 12 are arranged in the lateral direction perpendicular to the conveying direction 15 (lateral direction of sheet of FIG. 1(a)), and the carrying members 12 are simultaneously conveyed. However, as long as any of Conditions 1 to 4 described above is satisfied and the gas can be uniformly laterally ejected, the number of carrying members 12 arranged in the lateral direction is not limited. A larger number of rows increase productivity, and also increase the installation space of the equipment and difficulty in conveying or uniformly laterally ejecting gas.

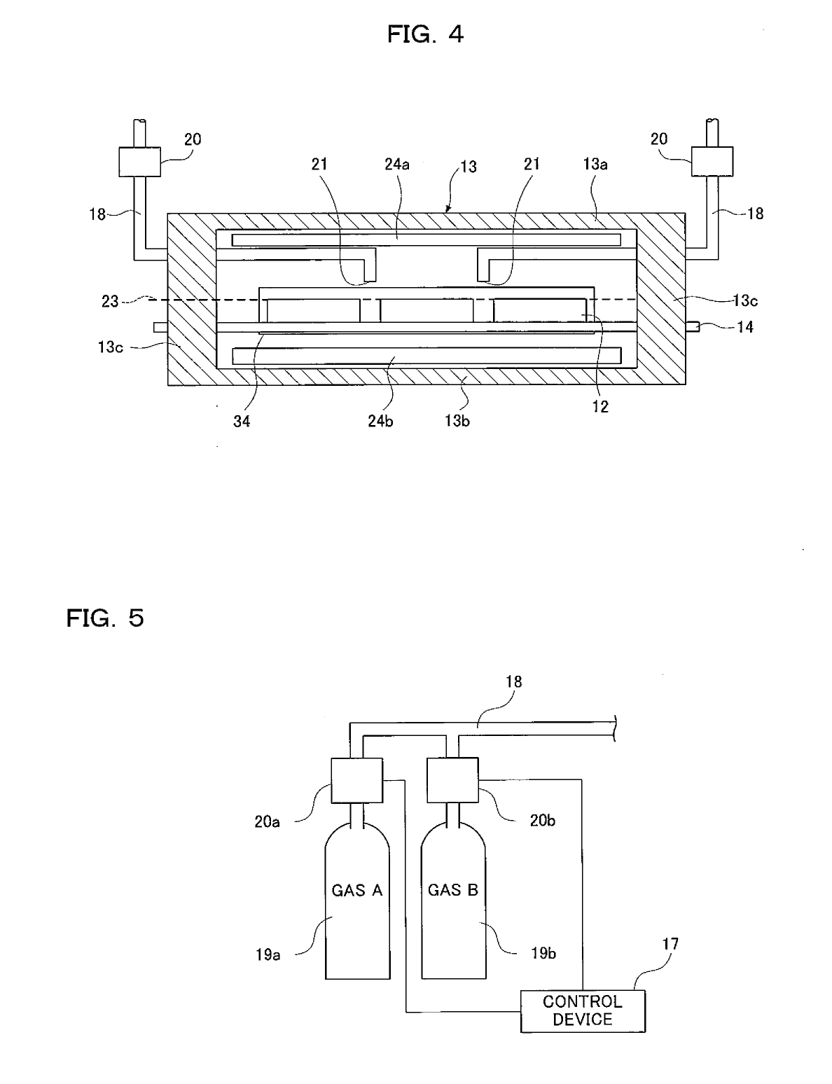

The case has been described where some of the plurality of gas ejection portions have different opening areas. However, for example, as shown in FIG. 4, a plurality of gas ejection portions 21 and air supply pipes 18 for supplying an atmospheric gas to the gas ejection portions 21 may be provided, and gas flow rate adjustment portions 20 for individually controlling the flow rate of the atmospheric gas ejected from the respective gas ejection portions 21 may be provided in the respective air supply pipes 18. This can also reduce variations in the flow rate of the atmospheric gas ejected from the gas ejection portions. FIG. 4 shows a configuration in which the two gas ejection portions 21 are provided, but of course, three or more gas ejection portions may be provided.

When the atmospheric gas contains two or more gas components, a gas flow rate adjustment portion may be provided in an atmospheric gas supply source for supplying each of the gas components. This enables the control of the flow rate of the atmospheric gas and the mixture ratio of components of the atmospheric gas. FIG. 5 schematically shows an example of a configuration that can control the mixture ratio of gas components. Specifically, FIG. 5 shows a configuration that can control the mixture ratio of two gas components.

When the mixture ratio of two gas components is controlled, for example, as shown in FIG. 5, a gas bomb 19a and a gas bomb 19b as atmospheric gas supply sources for individually storing a gas A and a gas B may be provided, and gas flow rate adjustment portions 20a and 20b may be provided in the gas bombs 19a and 19b, respectively. To the gas bombs 19a and 19b, the air supply pipe 18 branching off at points thereof is connected via the gas flow rate adjustment portions 20a and 20b. The gas flow rate adjustment portions 20a and 20b enable the adjustment of the flow rate of the atmospheric gas supplied to the air supply pipe 18, and the adjustment of the mixture ratio of the gas components. Thus, the two gas flow rate adjustment portions 20a and 20b constitute a gas component adjustment portion. As the gas flow rate adjustment portions 20a and 20b, for example, regulators or the like may be used. The atmospheric gas supply source is not limited to a gas bomb, but may be, for example, a gas generator or the like. Of course, the atmospheric gas is not limited to a gas containing two gas components.

The configuration in which the gas flow rate adjustment portions 20a and 20b are provided in the respective atmospheric gas supply sources for supplying the gas components as described above may be applied not only to a configuration in which the air supply pipe 18 passes through the furnace body 13 in the lateral direction, but also to a configuration in which air supply pipes 18 are provided for the respective gas ejection portions 21.

Next, the carrying member 12 will be described. As shown in FIGS. 1(a) and 1(b), in this embodiment, a box-shaped container having a square bottom surface is used as the carrying member 12. However, of course, the shape of the carrying member 12 is not limited, and, for example, a cylindrical box-shaped container or a plate-shaped member without brims may be used. However, when powder has high fluidity, a box-shaped container with brims is desirably used. This is because, in a plate-shaped carrying member 12 without brims, an amount of powder that can be carried by one carrying member is limited, thereby reducing productivity.

Next, materials for the carrying member 12 and the air supply pipe 18 will be described. In this embodiment, the carrying member 12 and the air supply pipe 18 are made of alumina ceramics, but of course, for example, any materials including a zirconia ceramic or metal such as SUS and inconel may be used as long as a use temperature condition is satisfied. However, in highly corrosive powder, a material having corrosion resistance is desirably used. This is because carried powder or flying powder causes the corrosion of the surface of the carrying member 12 or the air supply pipe 18, the surface is released, and the released object may be mixed into the powder 11 as an impurity.

Next, a heating portion for controlling temperature distribution in the inner space of the furnace body 13 will be described. The heating portion controls temperature distribution in the inner space of the furnace body 13 according to a burning process. In this embodiment, as the heating portion, a plurality of upper heaters (first heaters) 24a and a plurality of lower heaters (second heaters) 24b are provided with the conveying path of the carrying member 12 therebetween. Specifically, the plurality of pipe-shaped upper heaters 24a are placed along the conveying direction 15 on the upper side of the conveying roller 14 (the side of an upper wall 13a of the furnace body 13), and similarly, the plurality of pipe-shaped lower heaters 24b are placed along the conveying direction 15 on the lower side of the conveying roller 14 (the side of the lower wall 13b of the furnace body 13). The upper heaters 24a and the lower heaters 24b are placed so that the longitudinal direction of the upper heaters 24a and the lower heaters 24b is parallel to the lateral direction perpendicular to the conveying direction 15 (lateral direction of sheet of FIG. 1(a)). The upper heater 24a and the lower heater 24b are placed so that a distance between the upper heater 24a and the carrying member 12 is equal to a distance between the lower heater 24b and the carrying member 12. This configuration is for uniform heating in the vertical direction (front and back surfaces) of the carrying member 12.

As shown in FIG. 2, the upper heater 24a and the lower heater 24b are connected to an upper heater temperature controller 25a and a lower heater temperature controller 25b, respectively, and the temperature controllers 25a and 25b constitute an output adjustment portion for individually controlling the outputs, that is, the temperatures of the upper heater 24a and the lower heater 24b. The temperature controllers 25a and 25b are connected to the control device 17, and the control device 17 controls the temperature target values or the like of the upper heater 24a and the lower heater 24b.

In this embodiment, the upper heater 24a and the lower heater 24b have the same shape, but of course, the upper heater 24a and the lower heater 24b may have different shapes. The upper heater 24a and the lower heater 24b may be embedded, for example, respectively in the upper wall 13a and the lower wall 13b that constitute the furnace body 13.

In this embodiment, as the upper heater 24a and the lower heater 24b, electric heaters having a resistor housed in a pipe-shaped ceramic case are used. However, the type of a heating portion (upper heater 24a and lower heater 24b) is not limited to these, but various heaters may be used such as a panel electric heater or a gas burning heater.

An important specification of the heating portion (upper heater 24a and lower heater 24b) is high thermal uniformity in the lateral direction perpendicular to the conveying direction 15 (lateral direction of sheet of FIG. 1(a)). For example, uniform temperature distribution in the lateral direction of the powder 11 may be obtained by a specification with varying densities of the resistor in the ceramic case. Specifically, the density of the resistor in the ceramic case is varied so that the temperatures of the upper heater 24a and the lower heater 24b increase near the side wall 13c of the furnace body 13 where the temperature is easily reduced by heat radiation. This can prevent uneven temperature in the lateral direction perpendicular to the conveying direction 15, and prevent uneven burning. Thus, even when the carrying members 12 in multiple rows along the conveying direction 15 are arranged in the lateral direction perpendicular to the conveying direction 15 and the plurality of carrying members 12 arranged in multiple rows are simultaneously continuously conveyed, uneven temperature between the rows can be prevented, and uneven burning can be prevented.

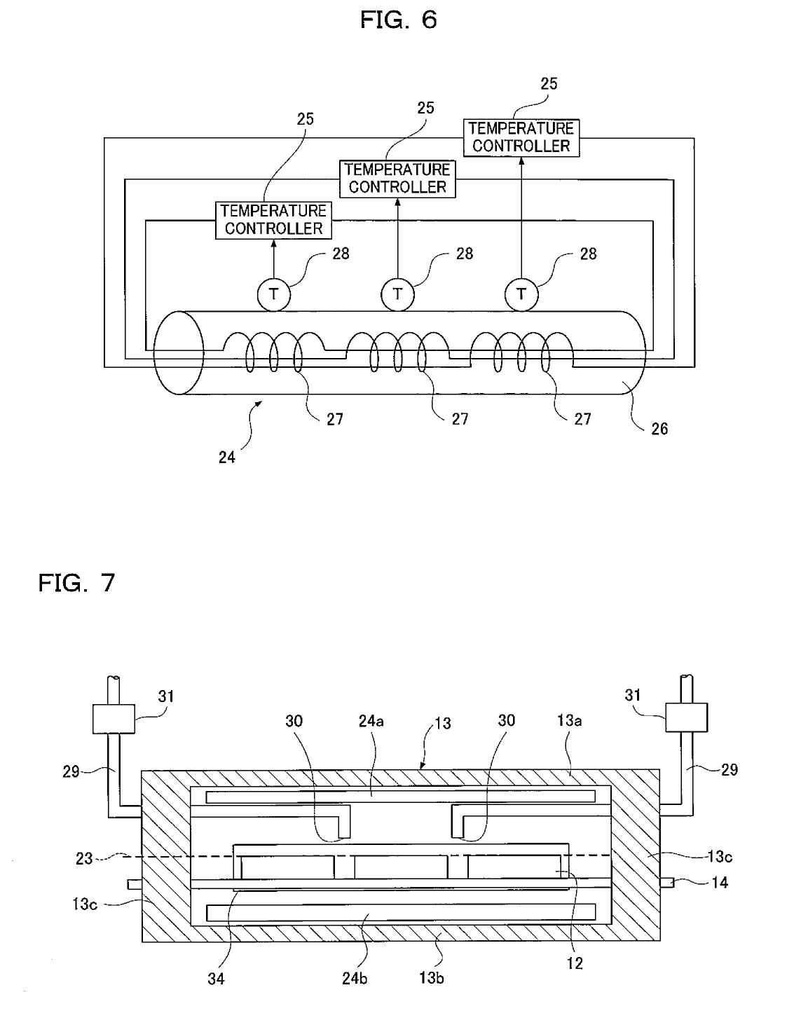

The density of the resistor in the ceramic case may be varied as described above. Alternatively, for example, the heating portion may be configured to control a temperature for each of a plurality of spots along the lateral direction perpendicular to the conveying direction 15 (lateral direction of sheet of FIG. 1(a)). FIG. 6 schematically shows an example of a configuration in which a temperature can be controlled for each of the spots along the lateral direction. FIG. 6 shows a configuration in which three spots for which the temperature can be controlled are provided in the lateral direction.

When the three spots for which the temperature can be controlled are provided, for example, as shown in FIG. 6, an electric heater having three resistors 27 arranged in a pipe-shaped ceramic case 26 correspondingly to the three spots for which the temperature is controlled may be used as the heater 24, and temperature controllers 25 may be provided for the respective three resistors 27. In this case, the temperature controllers 25 provided for the three resistors 27 may control the temperature based on a signal from a temperature detector 28 provided in each spot for which the temperature is controlled. As the temperature detector 28, for example, a thermocouple may be used. Also in this manner, uneven temperature in the lateral direction perpendicular to the conveying direction 15 can be prevented, and uneven burning can be prevented. Further, as compared with the case where the density of the resistor in the ceramic case is simply varied, finer temperature control can be performed. Also in this case, the density may be varied between the resistors 27.

Next, the furnace body 13 will be described. In this embodiment, the upper wall 13a above the upper heater 24a and the lower wall 13b below the lower heater 24b are heat insulating walls. The side walls 13c of the furnace body 13 facing each other in the horizontal direction are also heat insulating walls.

Next, the conveying method of the carrying member 12 will be described. In this embodiment, the carrying member 12 is conveyed by the rotation of the conveying roller 14. The conveying roller 14 has a thickness (strength) enough to bear the load of the carrying member 12 carrying the powder 11. The conveying rollers 14 are arranged at sufficiently shorter intervals than the length of the carrying member 12 along the conveying direction 15 so that the carrying member 12 does not fall. However, if the conveying rollers 14 are too thick or the conveying rollers 14 are arranged at too short intervals, heat transfer from the lower heater 24b to the carrying member 12 is prevented. Thus, in view of the factors, an appropriate thickness and interval of the rollers are desirably set. Of course, the conveying method of the carrying member 12 is not limited to the method of carrying the carrying member by the rotation of the conveying roller 14. For example, the conveying method may be a method of pushing a carrying member on a roller with a hydraulic pusher, or a method using a mesh belt conveyor.

Next, the angle θ formed by the normal to the imaginary surface 23 and the gas ejection direction 22 will be described. In this embodiment, the gas ejection direction 22 is set so that the angle θ is 45°, but of course, the angle θ is not limited to 45°. For example, the gas ejection direction 22 may be set so that the angle θ is 0°, and the atmospheric gas may be ejected perpendicularly to the surface layer of the powder 11. However, as described later, to arrange the passage of the atmospheric gas to be parallel to the conveying direction 15, the gas ejection direction 22 is desirably set so that 0°>θ>90° and the ejected atmospheric gas does not collide with an obstacle such as the upper heater 24a.

Next, the gas exhaust mechanism of the burning equipment will be described. The burning of the powder 11 progresses with contact between the ejected atmospheric gas and the powder 11 and the supply of heat from the upper heater 24a and the lower heater 24b to the powder 11. During the burning, an unnecessary gas is generated from the powder 11 by the volatilization or chemical reaction of a component contained in the powder 11. If the unnecessary gas is retained in the furnace body, a reverse reaction from a desired chemical reaction may occur in the powder 11. Thus, the unnecessary gas needs to be exhausted together with the atmospheric gas to the outside of the furnace body.

The gas exhaust mechanism of the burning equipment exhausts a gas sucked into a gas suction portion 30 in the furnace body 13 from the side wall 13c of the furnace body 13 to outside the furnace body 13. In this embodiment, the gas exhaust mechanism includes an exhaust pipe 29, the gas suction portion 30 provided in the exhaust pipe 29, and a gas exhaust amount adjustment portion 31 for causing a gas to be sucked through the exhaust pipe 29 into the gas suction portion 30 and controlling the flow rate of the gas sucked into the gas suction portion 30. As shown in FIG. 2, the gas exhaust amount adjustment portion 31 is connected to the control device 17, and the control device 17 controls a gas exhaust operation of the gas exhaust amount adjustment portion 31. As the gas exhaust amount adjustment portion 31, for example, an exhaust fan may be used.

The exhaust pipe 29 as a gas exhaust portion passes through the furnace body 13 in the lateral direction like the air supply pipe 18. The exhaust pipe 29 is placed above the conveying path of the carrying member 12 in the furnace body 13, and the exhaust pipe 29 exhausts the gas sucked into the gas suction portion 30 from the side wall 13c of the furnace body 13 to outside the furnace body 13. The exhaust pipe 29 is connected to the gas exhaust amount adjustment portion 31 outside the furnace body 13.

A plurality of gas suction portions 30 for sucking the gas in the inner space of the furnace body 13 are provided on the side surface of the exhaust pipe 29 in the furnace body 13. The gas suction portions 30 suck the gas from above the powder 11 conveyed in the inner space of the furnace body 13. In this embodiment, the gas suction portion 30 is an opening formed on the side surface of the exhaust pipe 29, and the gas is sucked through the opening.

The configurations and arrangements of the exhaust pipe 29 and the gas suction portion 30 are matched with the configurations and arrangements of the air supply pipe 18 and the gas ejection portion 21 so that the passage of the atmospheric gas ejected from the gas ejection portion 21 is parallel to the conveying direction 15. The shapes and materials of the exhaust pipe 29 and the gas suction portion 30 (including the shape of the opening of the gas suction portion 30) are desirably selected according to the same criteria of selection as the shapes and materials of the air supply pipe 18 and the gas ejection portion 21.

In this embodiment, the exhaust pipe 29 is placed in a direction opposite to the conveying direction 15 with respect to the air supply pipe 18, that is, in the upper position on the left of sheet of FIG. 1(b). As in the air supply pipe 18 of FIG. 3, a plurality of circular gas suction portions (openings) 30 are provided on the side surface of the cylindrical exhaust pipe 29. The plurality of gas suction portions 30 are provided in the same coordinate positions as the plurality of gas ejection portions 21 in the lateral direction (lateral direction of sheet of FIG. 1(a)). The areas of the gas suction portions (openings) 30 are set so that the flow rate of the gas sucked into the gas suction portions 30 is uniform. Specifically, as in the gas ejection portions 21 of FIG. 3, some of the gas suction portions 30 may have different opening areas, or all the gas suction portions (openings) 30 may have the same area as long as variations in the flow rate of the gas sucked into the gas suction portions 30 are within an acceptable range.

A gas suction direction 32 of the gas sucked into the gas suction portion 30 is desirably set so that an angle ψ formed by the normal to the imaginary surface 23 on the same level as the surface layer of the powder 11 and the gas suction direction 32 is within a range of 0°<θ<90, and the passage of the atmospheric gas is not interfered by an obstacle such as the upper heater 24a for the same reason as in the gas ejection direction 22. FIG. 1(b) shows an example of the gas suction direction 32 with an arrow. The gas suction direction 32 is set so that the angle ψ formed by the normal to the imaginary surface 23 and the gas suction direction 32 is 45°.

In the above configuration, the passage of the atmospheric gas ejected from each of the gas ejection portions 21 and sucked into each of the gas suction portions 30 is substantially parallel to the conveying direction 15. Thus, changes in gas composition and flow velocity in the passage of the atmospheric gas occur along the conveying direction of powder due to the fact that powder closer to the gas ejection portion is sequentially brought into contact with the atmospheric gas and undergoes a reaction. Thus, even if the composition and flow velocity of the atmospheric gas slightly change along the conveying direction 15 when the carrying members 12 in multiple rows along the conveying direction 15 are arranged in the lateral direction perpendicular to the conveying direction 15 and the carrying members 12 arranged in multiple rows are simultaneously continuously conveyed, all the powder 11 follows the same hysteresis of the atmospheric gas. Thus, uneven burning between the rows can be prevented as compared with the case where there are variations in gas composition and flow velocity in the lateral direction perpendicular to the conveying direction 15 (lateral direction of sheet of FIG. 1(a)).

The gas may be exhausted from opposite ends or one end of the exhaust pipe 29. Thus, the gas sucked into the gas suction portion 30 is exhausted to outside the furnace body 13 from at least one of the side walls 13c of the furnace body 13 facing each other in the lateral direction perpendicular to the conveying direction 15 (lateral direction of sheet of FIG. 1(a)), thereby allowing the plurality of furnace bodies to be stacked in multiple stages as described later in Embodiment 2.

The flow rates of the gas sucked into the gas suction portions 30 may be individually controlled. For example, gas exhaust amount adjustment portions may be provided near the respective gas suction portions 30. In this case, as the gas exhaust amount adjustment portion, for example, a damper may be used. Alternatively, for example, as shown in FIG. 7, the gas suction portions 30, and the exhaust pipes 29 connected to the respective gas suction portions 30 may be provided, and the gas exhaust amount adjustment portion 31 for individually controlling the flow rate of the gas sucked into the gas suction portion 30 may be provided in each of the exhaust pipes 29. FIG. 7 shows a configuration in which two gas suction portions 30 are provided, but of course, three or more gas suction portions may be provided. In this case, as the gas exhaust amount adjustment portion, for example, an exhaust fan may be used. Further, in the configuration of FIG. 7, instead of providing the gas exhaust amount adjustment portions 31 in the respective exhaust pipes 29, gas exhaust amount adjustment portions may be provided near the respective gas suction portions 30. In this case, as the gas exhaust amount adjustment portion, for example, a damper may be used. As described above, with the configuration in which the flow rates of the gas sucked into the gas suction portions 30 can be individually controlled, variations in the flow rates of the gas sucked into the gas suction portions 30 can be reliably reduced.

The furnace body 13 of the burning equipment is divided into a plurality of zones (treatment spaces) along the conveying direction 15 depending on the burning process. FIG. 1(b) shows a section of one of the zones. The zones are partitioned by zone bulkheads 33, and each zone bulkhead 33 has a passage hole 34 through which the carrying member 12 can pass.

The gas introduction mechanism, the gas exhaust mechanism, and the heating portions (upper heater 24a and lower heater 24b) are provided in a part or all of the plurality of zones depending on the burning process. For example, the gas exhaust mechanism may not be provided in a zone where the unnecessary gas is not generated. However, it is necessary that the atmospheric gases in the zone and the adjacent zone are of the same type, or the zone is not a start zone or an end zone. The gas exhaust mechanism needs to be provided in the start zone and the end zone to prevent leakage of hot air to outside the furnace body 13. The upper heater 24a and the lower heater 24b may not be provided in a zone where the powder 11 is quickly cooled. The gas introduction mechanism may not be provided in the end zone, but only the gas exhaust mechanism may be provided.

As described above, the heating portions (upper heater 24a and lower heater 24b) are individually provided in the respective zones, and thus the output of the heating portion can be optimized depending on heat supply to be performed in each zone such as the temperature increase of powder, uniform heating, and cooling. Further, the gas introduction mechanisms are individually provided in the respective zones, so that the flow rate of the atmospheric gas or the component mixture ratio of the atmospheric gas can be optimally controlled depending on heat treatment to be performed in each zone such as synthesis with a chemical reaction, removal of an impurity, improvement in crystal structure, and particle growth.

Next, a conveying detection portion 35 will be described. As shown in FIG. 2, the burning equipment includes the conveying detection portion 35. The conveying detection portion 35 detects whether or not the powder 11 is conveyed. The conveying detection portion 35 transmits a detection signal to the control device 17, the detection signal indicating whether or not the powder 11 is conveyed. When the powder 11 is not conveyed, the control device 17 as a control portion transmits signals for reducing the outputs of the upper heater 24a and the lower heater 24b to the upper heater temperature controller 25a and the lower heater temperature controller 25b, and transmits a signal for reducing the flow rate of the atmospheric gas supplied to the air supply pipe 18 to the atmospheric gas supply source 19 and/or the gas flow rate adjustment portion 20. This can reduce the energy consumption of the burning equipment when production is not performed, and reduce the running cost of the burning equipment.

During the burning of the powder 11, the volume or physical property of the powder 11 or a bonding force between particles changes with the progress of the burning. Thus, the burning equipment is desirably configured so that variables in view of the change are assigned to the equations in Conditions 1 to 4 above, and any one of the conditions is satisfied in all of the gas ejection portions in all of the zones.

Specifically, the burning equipment is configured so that in each of Conditions 1 to 4, the distance H between the imaginary surface 23 on the same level as the surface layer of the powder 11 and the gas ejection portion 21, and the flow velocity U of the atmospheric gas on the imaginary surface 23 on the extension line of the gas ejection direction 17 satisfy the relationship:

H=H′=Ho+ΔH

U<Uc′

Herein, Ho is a reference distance [mm] between a reference imaginary surface on the same level as the surface layer of the powder 11 before burning and the gas ejection portion 21, H′ is a variable distance [mm] between a variable imaginary surface on the same level as the surface layer of the powder 11 during burning and the gas ejection portion 21, ΔH is the variable width [mm] of the variable distance H′ [mm] due to changes in the volume of the powder 11 during burning, and Uc′ is a critical friction velocity [mm/s] at which the powder 11 during burning flies. The critical friction velocity Uc′ at which the powder 11 during burning flies is calculated by assigning a physical property value of the powder 11 during burning (particle size or density of the powder 11 during burning) and a proportional constant to the known expression for the critical friction velocity Uc described above. The proportional constant of the powder 11 during burning can be separately calculated by an experiment.

Any one of the conditions is satisfied in all of the gas ejection portions in all of the zones. Thus, even if changes in the volume of the powder 11 change the level of the surface layer of the powder 11, or changes in the physical property of the powder 11 and changes in the bonding force between particles change the critical friction velocity, appropriate gas supply depending on the changes can be performed, thereby preventing flying of the powder 11 and uneven gas supply. Thus, even when the furnace body 13 is divided into the plurality of zones along the conveying direction 15, the carrying members 12 in multiple rows along the conveying direction 15 are arranged in the lateral direction perpendicular to the conveying direction 15, and the carrying members 12 arranged in multiple rows are simultaneously continuously conveyed, the powder 11 is prevented from flying and a sufficient atmospheric gas can be uniformly brought into contact with the powder 11 with a small gas supply amount in all of the zones.

### Embodiment 2

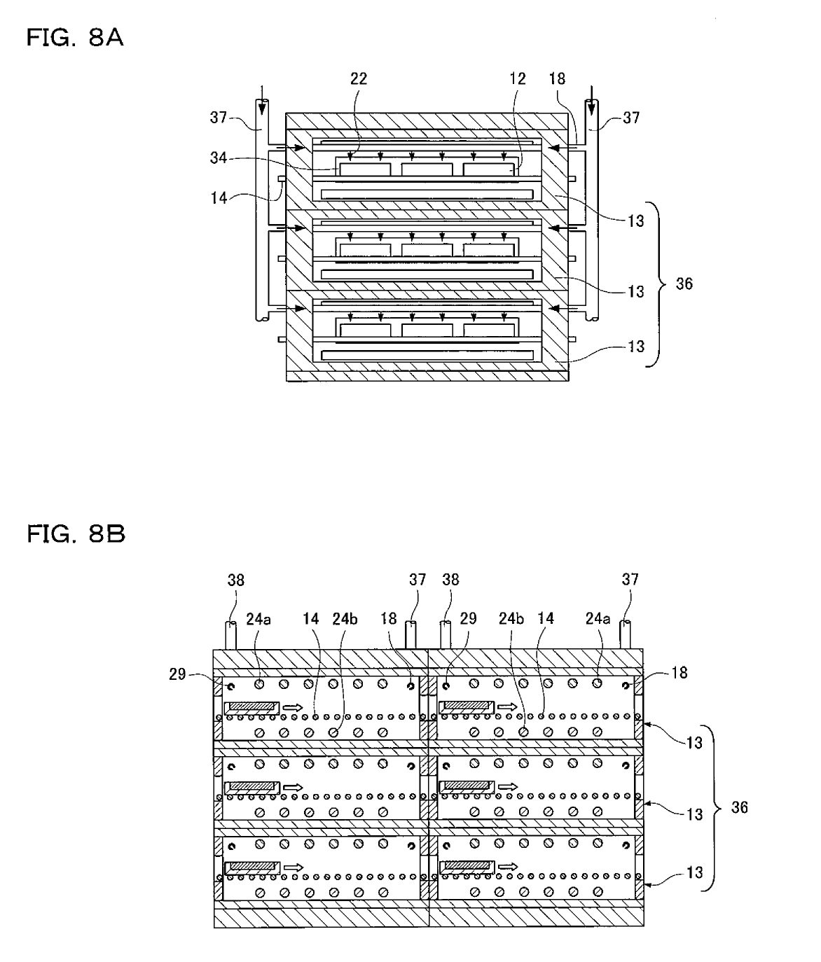

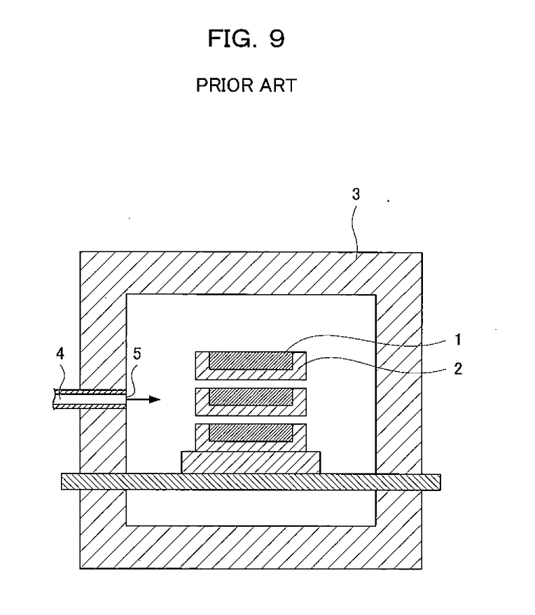

Now, Embodiment 2 of the present invention will be described with reference to the drawings. FIGS. 8(a) and 8(b) are sectional views showing an exemplary configuration of burning equipment of Embodiment 2 of the present invention. Specifically, FIG. 8(a) shows a section of a multistage furnace body cut along a plane perpendicular to the conveying direction of a carrying member carrying powder, and FIG. 8(b) shows a section of the multistage furnace body cut along a vertical plane along the conveying direction of the carrying member carrying powder. In FIGS. 8(a) and 8(b), the same components as the components of FIGS. 1(a) and 1(b) are denoted by the same reference numerals, and the descriptions thereof will be omitted.

This burning equipment has a configuration in which the furnace bodies 13 described in Embodiment 1 are stacked in multiple stages in a height direction (vertical direction). FIGS. 8(a) and 8(b) show a multistage furnace body 36 constituted by three stacked furnace bodies 13. However, the number of stages of the stacked furnace bodies is not limited to three, but any number of stages may be allowed within acceptable ranges of the installation height of the burning equipment and the withstand load of a floor. A larger number of stages increase the productivity and also increase difficulty in conveying and uniform supply of gas or heat to each stage.

An air supply pipe 18 provided in the furnace body 13 in each stage is connected to a merging air supply pipe 37 that is a part of a gas introduction mechanism outside the furnace body 13. The merging air supply pipe 37 is connected to an atmospheric gas supply source outside the furnace body 13 as in Embodiment 1. An exhaust pipe 29 provided in the furnace body 13 in each stage is connected to a merging exhaust pipe 38 that is a part of the gas exhaust mechanism outside the furnace body 13. The merging exhaust pipe 38 is connected to a gas exhaust amount adjustment portion outside the furnace body 13 as in Embodiment 1.

The furnace body 13 is divided into a plurality of zones along a conveying direction 15 as in Embodiment 1, and two of the zones are shown in FIG. 8(b). The gas introduction mechanism including the merging air supply pipe 37 and the gas exhaust mechanism including the merging exhaust pipe 38 are provided in each zone.

As in Embodiment 1, the supply of the atmospheric gas into the furnace body 13 and the exhaust of the gas to outside the furnace body 13 are performed from at least one side of side walls 13c of the furnace body 13. Thus, there is no need to provide a gas introduction mechanism and a gas exhaust mechanism on the upper and lower surfaces of the furnace body 13. This can reduce the height of the furnace body 13, and allows the furnace bodies 13 to be stacked in multiple stages in the height direction while saving space.

A temperature controller is desirably provided which individually controls the outputs of an upper heater 24a and a lower heater 24b. Thus, the outputs of the upper heater 24a and the lower heater 24b are optimally controlled, thereby avoiding the influence of heat radiation from the upper and lower surfaces of the multistage furnace body 36 to the outside. This can prevent the uneven temperature of carrying members 12 and powder 11 in each stage.

According to Embodiment 2, the powder 11 can be prevented from flying without the uneven temperature of the carrying members and the powder and uneven gas supply between stages as in the case where the carrying members are stacked in multiple stages in the height direction in one furnace body. This can significantly increase the productivity.

### INDUSTRIAL APPLICABILITY

The burning equipment according to the present invention can prevent uneven burning and increase productivity, and is useful in the fields having the process of continuously performing heat treatment on subjects to be treated which are carried by carrying members.

1. Burning equipment comprising:
a furnace body having an inner space in which a powdery or granular subject to be treated is burned;
a gas ejection portion having an opening for ejecting an atmospheric gas from above the subject to be treated which is conveyed in the inner space of the furnace body;
a gas supply portion for supplying the atmospheric gas from a side wall of the furnace body to the gas ejection portion; and
a heating portion for controlling temperature distribution in the inner space of the furnace body,
wherein when an area of the opening of the gas ejection portion is S [mm²], a flow rate of the atmospheric gas ejected from the gas ejection portion is Q [mm³/s], a distance between an imaginary surface on the same level as a surface layer of the powdery or granular subject to be treated which is conveyed in the inner space of the furnace body and the gas ejection portion is H [mm], an angle formed by a normal to the imaginary surface and an ejection direction of the atmospheric gas is θ [°], a flow velocity of the atmospheric gas on the imaginary surface on an extension line of the ejection direction of the atmospheric gas is U [mm/s], and a critical friction velocity at which the subject to be treated flies is Uc [mm/s], the distance H between the imaginary surface and the gas ejection portion is 300 [mm] or less, and any one of Conditions 1 to 4 below is satisfied:
U=0.0315×S^{-0.5}×Q
H/cos θ≦80
U<Uc (Condition 1)
U=(1.694+0.0105×H/cos θ)×S^{-0.5}×Q×cos θ/H
80<H/cos θ≦150
U<Uc (Condition 2)
U=(5.476−0.0142×H/cos θ)×S^{-0.5}×Q×cos θ/H
150<H/cos θ>300
U<Uc (Condition 3)
U=S^{-0.5}×Q×cos θ/H
H/cos θ>300
U<Uc (Condition 4)

2. (canceled)

3. (canceled)

4. The burning equipment according to claim 1, wherein when a reference distance between a reference imaginary surface on the same level as the surface layer of the powdery or granular subject to be treated which is conveyed in the inner space of the furnace body before burning and the gas ejection portion is Ho [mm], a variable distance between a variable imaginary surface on the same level as the surface layer of the subject to be treated during burning and the gas ejection portion is H′ [mm], a variable width of the variable distance due to changes in volume of the subject to be treated during burning is ΔH [mm], and a critical friction velocity at which the subject to be treated during burning flies is Uc′ [mm/s], in any one of Conditions 1 to 4, the distance H [mm] between the imaginary surface on the same level as the surface layer of the subject to be treated and the gas ejection portion, and the flow velocity U [mm/s] of the atmospheric gas on the imaginary surface on the extension line of the ejection direction of the atmospheric gas ejected from the gas ejection portion satisfy a relationship:
H=H′=Ho+ΔH
U<Uc′.

5. The burning equipment according to claim 4, wherein the gas ejection portion comprises a plurality of gas ejection portions having the opening for ejecting the atmospheric gas which are provided in a direction perpendicular to a conveying direction of the subject to be treated.

6. The burning equipment according to claim 5, wherein some of the plurality of gas ejection portions have different areas in the opening for ejecting the atmospheric gas.

7. The burning equipment according to claim 5, further comprising a gas flow rate adjustment portion for controlling flow rates of the atmospheric gas ejected from the plurality of gas ejection portions for the respective gas ejection portions.

8. The burning equipment according to claim 5, further comprising a gas component adjustment portion for controlling component mixture ratios of the atmospheric gas ejected from the plurality of gas ejection portions for the respective gas ejection portions.

9. The burning equipment according to claim 1, further comprising a bulkhead for dividing the inner space of the furnace body into a plurality of treatment spaces along a conveying direction of the subject to be treated depending on a burning process,
wherein the gas supply portion, the gas ejection portion, and the heating portion are provided in all or a part of the plurality of treatment spaces depending on the burning process.

10. The burning equipment according to claim 9, further comprising a gas flow rate adjustment portion for controlling a flow rate of the atmospheric gas ejected from the gas ejection portion for each of the treatment spaces.

11. The burning equipment according to claim 9, further comprising a gas component adjustment portion for controlling a component mixture ratio of the atmospheric gas ejected from the gas ejection portion for each of the treatment spaces.

12. The burning equipment according to claim 1, further comprising:
a gas suction portion having an opening for sucking a gas in the inner space of the furnace body from above the powdery or granular subject to be treated which is conveyed in the inner space of the furnace body; and
a gas exhaust portion for exhausting the gas sucked into the gas suction portion from the side wall of the furnace body to outside the furnace body,
wherein the gas ejection portion and the gas suction portion are arranged so that a passage of the atmospheric gas ejected from the gas ejection portion is parallel to a conveying direction of the subject to be treated.

13. The burning equipment according to claim 12, wherein the gas suction portion comprises a plurality of gas suction portions having the opening for sucking the gas in the inner space of the furnace body which are provided in a direction perpendicular to the conveying direction of the subject to be treated.

14. The burning equipment according to claim 9, further comprising:
a gas suction portion for sucking a gas in the inner space of the furnace body from above the powdery or granular subject to be treated which is conveyed in the inner space of the furnace body; and
a gas exhaust portion for exhausting the gas sucked into the gas suction portion from the side wall of the furnace body to outside the furnace body,
wherein the gas suction portion and the gas exhaust portion are provided in all or a part of the plurality of treatment spaces depending on the burning process, and
the gas ejection portion and the gas suction portion are arranged so that a passage of the atmospheric gas ejected from the gas ejection portion is parallel to the conveying direction of the subject to be treated.

15. The burning equipment according to claim 1, wherein the furnace body comprises a plurality of furnace bodies stacked in multiple stages.

16. The burning equipment according to claim 1, wherein the heating portion provides uniform temperature distribution along a direction perpendicular to a conveying direction of the subject to be treated.

17. The burning equipment according to claim 1, wherein the heating portion includes a first heater and a second heater placed with a conveying path of the subject to be treated therebetween.

18. The burning equipment according to claim 17, wherein the first heater and the second heater comprise a plurality of first heaters and a plurality of second heaters, respectively, which are placed along a conveying direction of the subject to be treated.

19. The burning equipment according to claim 17, further comprising an output adjustment portion for individually controlling outputs of the first heater and the second heater.

20. The burning equipment according to claim 1, further comprising:
a detection portion for detecting whether or not the subject to be treated is conveyed; and
a control portion for reducing an output of the heating portion and a supply flow rate of the atmospheric gas when the detection portion detects that the subject to be treated is not conveyed.
